(19) United States
(12) Patent Application Publication
(10) Pub. No.: US 2017/0237510 A1
(43) Pub. Date: Aug. 17, 2017

(54) VARIABLE TIME OFFSET IN A SINGLE FREQUENCY NETWORK TRANSMISSION SYSTEM

(71) Applicant: INSTITUT FUR RUNDFUNKTECHNIK GMBH, Munich (DE)

(72) Inventor: Stefan Teuscher, Messkirch (DE)

(21) Appl. No.: 15/501,700

(22) PCT Filed: Aug. 4, 2015
(86) PCT No.: PCT/IB2015/055912

§ 371 Date: Feb. 3, 2017

(30) Foreign Application Priority Data
Aug. 5, 2014 (IT) MI2014A001428

(51) Int. Cl. H04H 20/67; H04L 27/26

(52) U.S. Cl. CPC H04H 20/67; H04L 27/2646

(57) ABSTRACT

A transmission system to transmit an information signal in a single-frequency network (SFN) includes a plurality of transmitters to transmit the information signal to at least one receiver, wherein at least one transmitter of the transmission system is adapted to transmit the information signal (IS) with a time offset, wherein the time offset varies over time, thereby the information signal (IS) transmitted by the at least one transmitter is received with a second time offset by the at least one receiver, in order to enhance the reception quality and minimize a signal cancelation.

### FIELD OF THE INVENTION

The invention relates to transmitters, transmission systems, transmission methods, and displacement units in a “isofrequential” network, known as Single Frequency Network (SFN). A transmission system according to the preamble of claim 1 is known from DE19644430.

### BACKGROUND OF THE INVENTION

A single frequency network (SFN) consists of a plurality of transmitters, which are spatially distributed over a contiguous area and broadcast identical information synchronously to one another and with use of the same transmission frequency. It is known that in an SFN a transmission area is supplied with the same information signal and thus is available to many users or receivers. The information signals broadcast in the broadcasting area of the transmitters add up constructively, so that uninterrupted reception is assured. In some cases, however, destructive interference can occur in the broadcasting area or transmission area, e.g., because of reflections on buildings of an information signal, broadcast by a transmitter.

It is also known that to realize SFNs, laborious and cost-intensive calculations are carried out to establish the locations of transmission stations. It is again disadvantageous in this regard that a location determination for transmission stations always represents a static spatial basic state, which can no longer be changed after the installation of the transmission stations. Consequently, poor reception can no longer be counteracted.

### BRIEF DESCRIPTION OF THE INVENTION

The object of the invention is to propose a transmission system, a transmission method, a transmitter, and a displacement unit in order to improve reception.

The object of the invention is achieved by the features specified in the independent claims. Further advantageous embodiments of the invention can be obtained from the dependent claims with the associated features.

The claims are integral part of the present description.

The present invention according to a first aspect proposes providing a transmission system to transmit an information signal in a single frequency network (SFN) comprising a plurality of transmitters to transmit the same information signal to at least one receiver, the transmission system being characterized in that at least one transmitter of the transmission system is adapted to transmit the information signal with a time offset, wherein the time offset varies over time.

Thus, the time offset is subjected to continuous variation or change, so that the absolute time offset during transmission of the information signal by at least one of the transmitters of the transmission system changes over time. It is self-evident that the term “time offset” is defined in comparison with another transmission time or a planned transmission time of the information signal. Thus, a time offset arises when based on a first actual or planned transmission time of the information signal the information signal is transmitted with a time offset, namely, earlier or later than the first transmission time. In addition, the time offset is to be understood as either a positive or a negative displace of the transmission time on the time axis. The variation of the time offset over time means that a continuous change in the time offset over time is provided. In this regard, the time offset changes depending on a provided clock or a provided sample rate on the base of certain time intervals and assumes a different value, whereby an intermittent repetition of the time offset with the same value is not ruled out.

The aim of the invention is to provide the reception of information signals with a time offset. The present invention proposes to implement a continuously varying time offset, so that if a signal cancelation is given because of reflections or destructive interferences in a given reception place, the signal cancelation will be eliminated or minimized in consequence of the continuously varying time offset. It is important to emphasize that the implementation of over-time varying time offsets according to the present invention is not aimed to increase the synchronicity of received information signals at the point of reception on the receiver side, but on the contrary that to provide a time offset at the point of reception, whereby the time offset varies over time. The invention proposes that in a transmission system at least one transmitter is adapted to transmit the information signal with an over-time varying time offset thereby said information signal transmitted by said at least one transmitter is received with a time offset by at least one receiver, in order to enhance the reception quality and in particular to minimize a signal cancelation.

The object of the invention in particular is to improve reception in a transmission area of a single frequency network SFN. Furthermore, a subsequent improvement of the reception of information signals is made possible according to the invention, although there is a transmitter-side fixed local installation of the transmission stations.

The information signal comprises both useful signals, which may be, for example, audio information, video information, or speech, and signal components, which are used for structuring, coding, or identification in an information signal, and help in the transmission and receiver-side processing.

Either the interfering information signals originate from different transmitters or an interference of information signals occurs due to reflections, so that the information signal interferes with a reflected information signal at the receiving location. The aforementioned problem is solved in an advantageous manner by the present invention. Furthermore, the reflection-induced interference, which can often be attributed to unfavorable topography conditions at the particular receiving location, is minimized or prevented according to the invention. In the case of destructive interference, the emitted information signals interfere with each other such that the information signals are partially or totally canceled, so that a receiver receives the information signal either not at all or only partially, whereby depending on the cancellation rate or signal receiving percentage, the partially received information signals can prove to be unusable, because the information signal cannot be reconstructed by the receiver, so that there is a poor reception. The aforementioned problem is also solved in an advantageous manner by the present invention or at least partially rectified.

According to a further advantageous aspect of the present invention, the time offset varies over time in accordance with a periodic function or a random pattern. In this regard, periodic functions in particular are used for generating time offsets. Further, the utilization of a random pattern for generating time offsets is also used advantageously. A suitable random generator generates the random pattern.

According to a further advantageous aspect of the present invention, the transmission system is characterized in that the transmitter is provided with a control unit to generate a control signal and a displacement unit to displace the information signal in time dependent on the control signal, wherein the displacement unit is adapted to displace the information signal according to the time offset which varies over time and is dependent on the control signal. The transmitter is equipped with a control unit or control signal generating unit, so that, depending on the time offset to be varied over time, the control unit generates control signals so that the transmitter transmits the information signal with the appropriate time offsets.

According to a further advantageous aspect of the present invention, the transmission system comprises at least two transmitters to transmit the information signal with time offsets which vary over time, wherein at least two of the varying time offsets are different. In this case, the use of at least two different time offsets which vary over time is advantageously proposed. Consequently, a plurality of time offsets which vary over time are used in the transmission of the information signal, so that each information signal is transmitted by one transmitter of the transmission system with a different time offset which vary over time.

A further advantageous aspect of the invention is that the transmission system is adapted to work according to an orthogonal frequency-division multiplexing method OFDM.

Further, the invention advantageously provides a transmitter to transmit an information signal in a single frequency network (SFN), with an input to receive an information signal and an output, wherein the transmitter is characterized in that it is adapted to transmit the information signal with a time offset, wherein the time offset varies over time. Further, the invention advantageously proposes that the time offset varies over time in accordance with a periodic function or a random pattern.

According to a further advantageous aspect of the present invention, the invention provides a displacement unit for the time displacement of information signals. The displacement unit according to the invention is characterized in that it is provided with a control signal generating unit and a controllable delaying unit, wherein the control signal generating unit is adapted to generate a control signal dependent on a symbol clock of an information signal, and the delaying unit is adapted to delay the information signal synchronously to the symbol clock dependent on the control signal, according to a time offset which varies over time. The displacement unit comprises a delaying unit, whereby the term “delaying unit” is taken to mean a unit for the displacement of information signals in time, either in a positive or negative direction, so that both a delay of the information signal and a precedence or advance transmission of the information signal relative to another information signal is implied. Preferably, the displacement unit of the invention is adapted to delay the information signal taking account of the symbol clock of the information signal. A synchronous delay or displacement of the information signal is taken to mean in particular that a change in a time offset takes into account the duration of the symbol clock or symbol length and/or the ending time of the symbol length. Preferably, a change in the time offset occurs according to a time offset course which varies over time at the beginning or at the end of a symbol, so that a synchronicity arises due to a clocked delay of the information signal in the symbol clock. Clocking for a delay can occur according to an established arbitrary number of symbols. Furthermore, a variable clocking for delaying information signals can also be used according to the invention.

Further, the displacement unit of the invention is preferably adapted to either derive the symbol clock of the information signal or it uses an information already provided and corresponding to the symbol clock of the information signal.

According to a further advantageous aspect of the present invention, the displacement unit is adapted to be integrated centrally, as a module, or locally distributed into the transmission system. In this way, advantageously a subsequent equipping of already available transmitters for transmitting information signals with a time-dependent offset is made possible. The displacement unit is particularly adapted to be integrated into a transmission system or a transmitter at a central location or as separate elements.

According to a further advantageous aspect of the present invention, the displacement unit is realized at least partially based on software.

According to a further advantageous aspect, the invention proposes a method to transmit an information signal in a single frequency network (SFN). The transmission system according to the method comprises a plurality of transmitters to transmit the same information signal to at least one receiver, whereby the method is characterized in that at least one transmitter of the transmission system transmits the information signal with a time offset, wherein the time offset varies over time. Further, the present invention advantageously proposes that the time offset of the method of the invention varies over time in accordance with a periodic function or a random pattern.

Preferably, the value range between a minimum value and a maximum value of a time offset trend is a specific percentage of a guard interval or a cyclic prefix.

Preferably, the value range is in particular 10% of the guard interval or cyclic prefix.

Further, preferably the value range is 0.2 to 0.9 microseconds in particular, whereby the guard interval or the cyclic prefix according to LTE (Long Term Evolution) in presence of a normal cyclic prefix is 4.7 microseconds in particular.

Further, preferably the value range is 0.8 to 3 microseconds in particular, whereby the guard interval or the cyclic prefix according to LTE (Long Term Evolution) in presence of an extended cyclic prefix is 16.7 microseconds in particular.

Further, preferably the value range is 10 to 50 microseconds in particular, whereby the guard interval or the cyclic prefix according to T-DAB (Terrestrial Digital Audio Broadcasting) in presence of a mode III is 246 microseconds in particular.

Further, preferably the value range is 10 to 50 microseconds in particular, whereby the guard interval or the cyclic prefix according to DVB-T (Digital Video Broadcasting-Terrestrial) in presence of the variants of 8 MHz, 8k-IFFT, and guard interval 1/4 is 224 microseconds in particular.

Further, preferably the value range is 10 to 50 microseconds in particular, whereby the guard interval or the cyclic prefix according to DVB-T 2 (Digital Video Broadcasting-T2) in presence of the variants of 8 MHz, 8k-IFFT, and guard interval 1/4 is 224 microseconds in particular.

Further, preferably the value range is 10 to 50 microseconds in particular, whereby the guard interval or the cyclic prefix according to DRM (Digital Radio Mondial) in presence of mode E, also known as DRM+, is 250 microseconds in particular.

It should be mentioned that DE19644430 discloses that information signals of a single frequency network are transmitted in different directions at different times. However, according to DE19644430, the emission of information signals at different times is fixed (constant) in time.

It should be mentioned further that U.S. Pat. No. 5,077,759 discloses a radio system in which a plurality of transmitters are controlled by a central station such that they emit radio signals at different times. Here as well, the different times are fixed (constant) in time.

### BRIEF DESCRIPTION OF THE DRAWINGS

Further purposes and advantages of the present invention will become fully clear from the following detailed description of an embodiment example thereof (and variants), and with reference to the attached drawing figures given by way of a mere exemplifying and non-limiting example, wherein:

FIG. 1 shows two transmission stations with the associated transmission areas and an overlap area in a single frequency network according to the prior art, to clarify the destructive interference problem.

FIG. 2 shows along a time axis, the emission of an information signal by a first transmitter and the emission of the information signal with a delay or a positive time displacement of the information signal by a second transmitter.

FIG. 3 shows along a time axis the emission of an information signal by a first transmitter and the emission of the information signal with a negative time offset by a second transmitter.

FIG. 4 shows along a time axis the emission of an information signal by a first transmitter and the emission of the information signal with a delay or a positive time offset and a negative time offset by a second transmitter.

FIG. 5 shows a block diagram of a transmitter with a displacement unit for the time-dependent displacement of an information signal.

FIG. 6 shows some exemplary embodiments according to the invention of different offset trends over time, versus the time-dependent displacement of information signals.

FIG. 7 shows an exemplary embodiment according to the invention of an offset trend according to an exemplary random pattern, versus the time-dependent displacement of information signals.

The same reference numerals and letters in the figures designate the same or functionally equivalent parts.

### DETAILED DESCRIPTION OF THE PREFERRED EMBODIMENTS

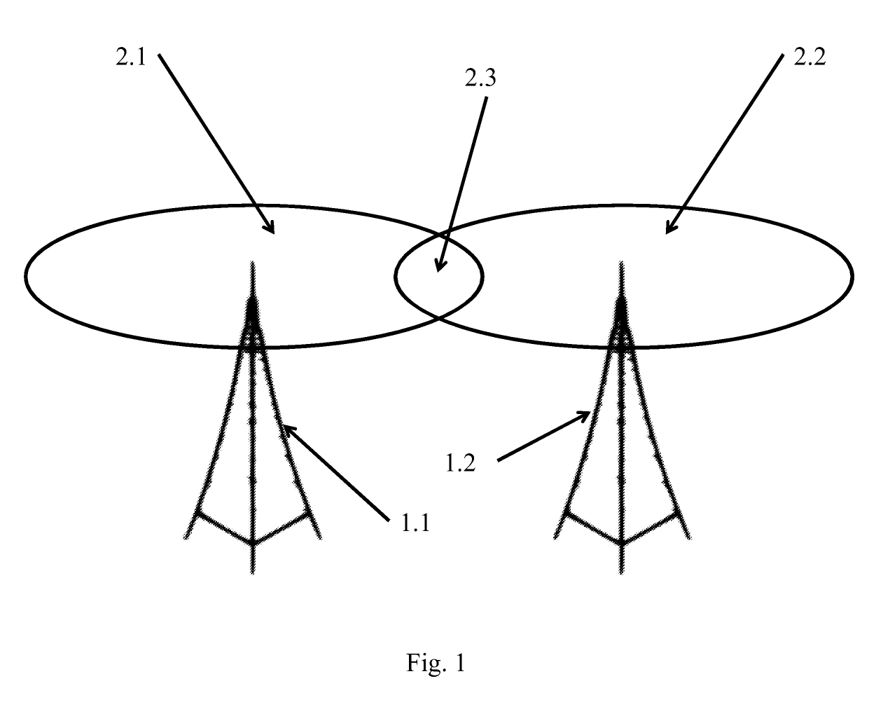

FIG. 1 shows a transmitter 1.1 with a transmission area 2.1 and a further transmitter 1.2 with a transmission area 2.2. Transmitters 1.1 and 1.2 transmit information signals with use of the same frequency and thus form a single frequency network (SFN). Transmitters 1.1 and 1.2 are arranged in such a way that the associated transmission areas 2.1 and 2.2 overlap partially and consequently form an overlap area 2.3. Interferences occur in overlap area 2.3. The interferences in overlap area 2.3 are generally constructive in nature, because of the fact that there is an SFN. They can also be destructive, however. If there is a destructive interference in overlap area 2.3, the information signals are partially or totally canceled and thus the information signal to be received by a receiver is unusable. It should also be mentioned here that a destructive interference can also occur in other areas of transmission areas 2.1 and 2.2, if the information signal interferes destructively with a reflected information signal and is canceled at least partially and thereby an information signal to be received is unusable.

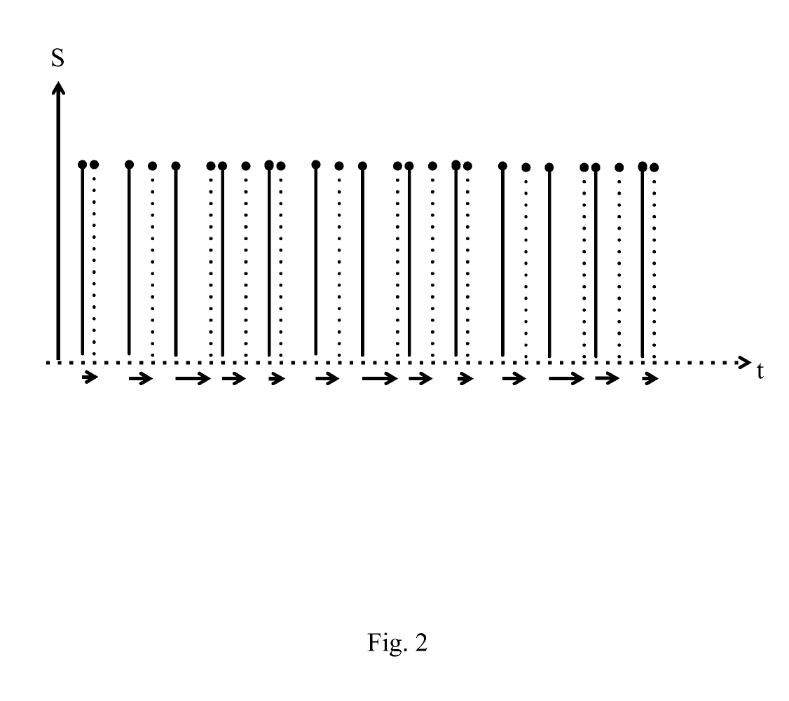

FIG. 2 shows a time sequence during the transmission of an information signal by two transmitters along a horizontal time axis t. The vertical axis S symbolizes the transmission with a first transmitter and with a second transmitter. The information signal, sent by the first transmitter, is symbolized by the solid vertical lines and the information signal, sent by the second transmitter, by the dotted vertical lines. The dotted vertical lines symbolize information signals sent with a time offset. The time offset in FIG. 2 is positive for all parts of the information signal. This means that the information signal with the dotted vertical lines, displaced by the second transmitter, is sent after the corresponding part of the information signal sent by the first transmitter. The presence of a time displacement or displacement, positive over time, of the information signal is symbolized by corresponding arrows parallel to the time axis t. The different length of the various arrows makes clear the different offset amounts. The amounts of the time offset in FIG. 2 follow a periodic trend, so that time offsets with same amounts are repeated after four steps. The aforementioned periodic trend is made clear by the respective arrow lengths or by counting the points on the time axis t between the sent information signal by the first transmitter and the sent information signal by the second transmitter.

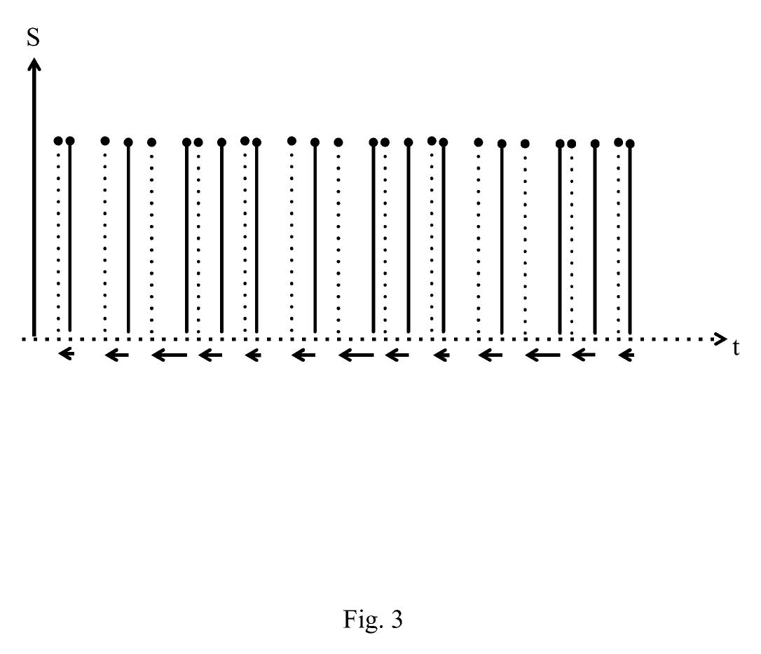

FIG. 3, as FIG. 2, shows a time sequence of the emission of an information signal by two transmitters along a horizontal time axis t. Reference is made herewith to the description of FIG. 2, whereby in contrast to the embodiment variant of the invention in FIG. 2, the time sequence shown in FIG. 3 in the sending of the information signal only has a negative time offset. Thus, the information signal is sent earlier by the second transmitter than the information signal sent by the first transmitter. The early transmission by the second transmitter is made clear, on the one hand, by a placement of the dotted vertical lines before the solid lines and, on the other hand, by the reverse arrow direction of the arrows arranged parallel to the time axis.

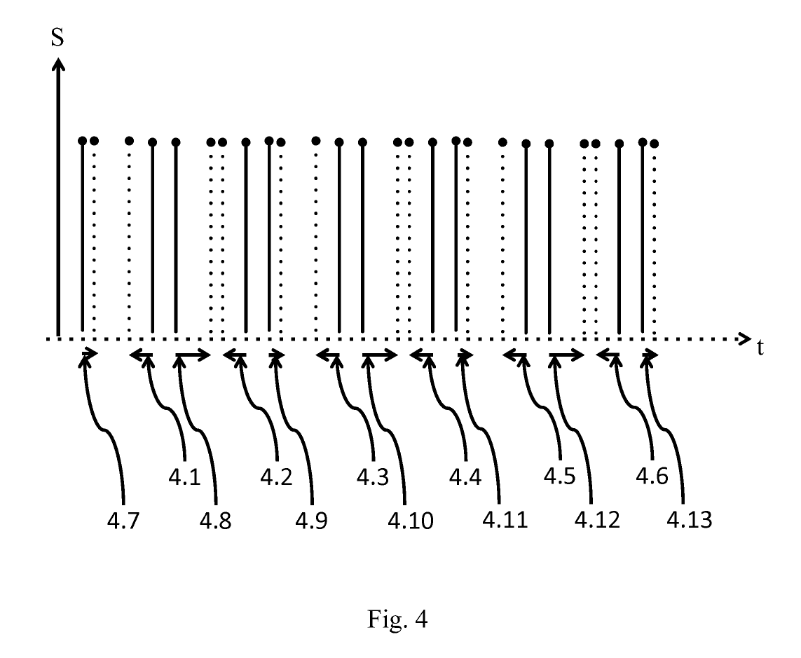

FIG. 4, as in FIG. 2 and FIG. 3, shows a time sequence during the transmission of an information signal by two transmitters along a horizontal time axis t. In contrast to FIGS. 2 and 3, with reference to the figure descriptions for FIGS. 2 and 3, FIG. 4 shows both a positive and a negative offset in the sending of the information signal. Thus, the second transmitter sends the information signal both before and also after the information signal that was sent by the first transmitter. To clarify the aforementioned situation, dotted vertical lines are arranged before and also after the respective solid vertical lines. Furthermore, the arrow directions of the arrows arranged parallel to the time axis t symbolize a positive offset over time and also a negative offset over time 4.1, 4.2, 4.3, 4.4, 4.5, and 4.6.

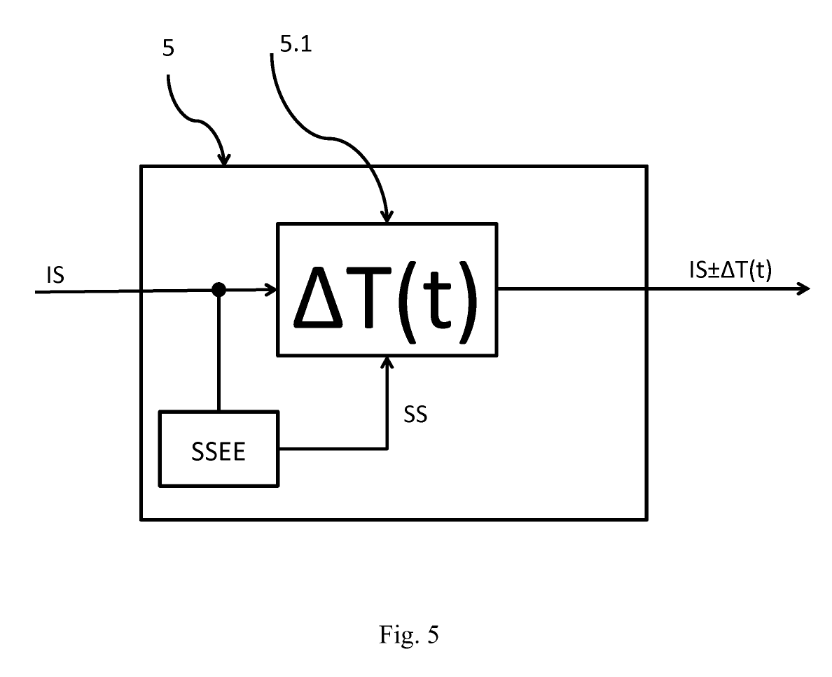

FIG. 5 shows a block diagram of a transmitter, provided with a displacement unit 5 with a delaying unit 5.1 for the time-dependent displacement of an information signal IS depending on a control signal SS, whereby the control signal SS is generated by a control signal generating unit SSEE. Displacement unit 5 associates information signal IS with a time-dependent offset varying over time ΔT(t). The time dependence of the offset ΔT(t) is shown with the control variable t, which stands for time, in delaying unit 5.1. The time displacement of information signal IS occurs as a function of the control signal SS generated by control signal generating unit SSEE. After information signal IS has been displaced with a time offset, a displaced information signal IS±ΔT(t) is available to displacement unit 5 on the output side.

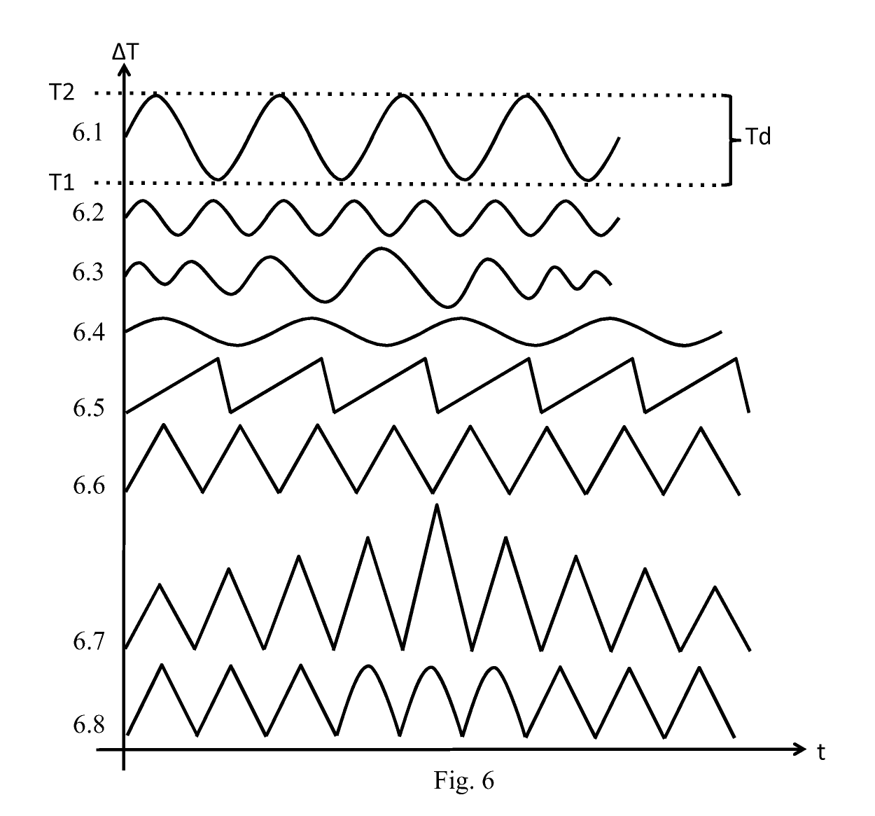

FIG. 6 shows, in a coordinate system comprising the axes of time offset ΔT and time t, some exemplary embodiments according to the invention of offset trends 6.1, 6.2, 6.3, 6.4, 6.5, 6.6, 6.7, and 6.8, which, in each case, assume different values of time offsets ≢T over time t. FIG. 6 shows a number of trigonometric offset trends 6.1, 6.2, 6.3, and 6.4 with different frequencies, amplitudes, and period lengths. Furthermore, FIG. 6 shows other sawtooth-shaped offset trends 6.5, 6.6, and 6.7. In addition, a composite offset trend 6.8 consisting of a sawtooth-shaped and a trigonometric offset trend 6.8 is shown in FIG. 6. The offset trends 6.1, 6.2, 6.3, 6.4, 6.5, 6.6, 6.7, and 6.8, as shown in FIG. 6, serve as an example and do not limit the subject of the invention. The frequencies, amplitudes, and period lengths vary as a reciprocal of the frequency of offset trends 6.1, 6.2, 6.3, 6.4, 6.5, 6.6, 6.7, and 6.8 and, as shown by way of example in regard to offset trend 6.1, the offset trend assumes a value between a minimum value T1 and a maximum value T2, so that a value range as a difference value Td results. Furthermore, as is shown in offset trends 6.3 and 6.7, there can be a temporary increase or moving upwards and decrease or moving downwards of offset values in the offset trend. In this case, however, a symmetric decrease or moving downwards or increase or moving upwards is not obligatory and can be provided or generated arbitrarily. In addition, it should be pointed out that the offset trends 6.1, 6.2, 6.3, 6.4, 6.5, 6.6, 6.7, and 6.8 can be displaced vertically along the ΔT axis, so that the time axis t is not to be understood to be an absolute zero point. Thus, offset trends as well belong to an embodiment variant of the invention, even if the offset trend is located partially or completely in a negative area of ΔT, and thus the intent is not a delay but a transmitting in advance of an information signal in comparison with another information signal. However, if the offset trend is located only partially in the negative area of ΔT, the intent thereby is an offset trend that executes both a delay and a transmitting in advance of an information signal relative to the transmission of another information signal. Further, as could be demonstrated by way of example with offset trend 6.8, different offset courses for displacement a single information signal can be combined with one another.

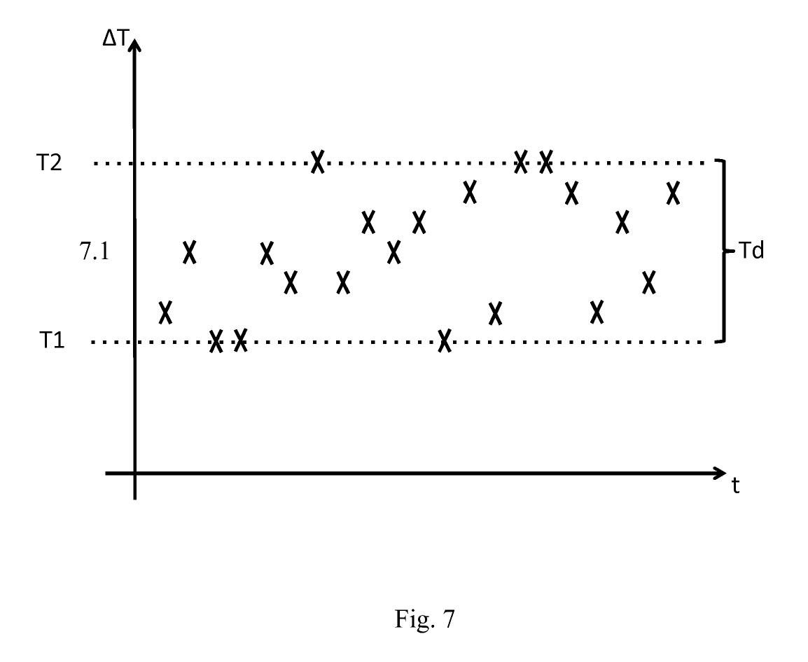

FIG. 7 shows, in a coordinate system with the axes of time offset ΔT and time t, a further embodiment according to the invention of an offset trend 7.1 generated according to a random pattern. The random values generated according to a random pattern are symbolized by crosses X between a minimum value T1 and a maximum value T2 with a value range Td. The generation of the random values can also occur according to different indications. These indications can cover different minimum values, maximum values, value ranges, weightings of probabilities of certain values or time offset values and/or frequencies or other characteristic mathematical features, so that both true random values and pseudo-random values are used for the time offset values. In this regard, periodically generated random values can also be generated. Furthermore, the description of variation options, described for FIG. 6, also applies to FIG. 7.

The value ranges for the time offsets can be derived as follows from the table below.

A list of different, important, and/or exemplary OFDM systems or system variants is given in the table:

| | | Guard | Maximum |
|---|---|---|---|
| System | Variant | Interval | Variation Range |
| LTE | Normal cyclic prefix | 4.7 μs | 0.2 μs to 0.9 μs |
| (Long Term | | | |
| Evolution) | | | |
| LTE | Extended cyclic | 16.7 μs | 0.8 μs to 3 μs |
| (Long Term | prefix | | |
| Evolution) | | | |
| T-DAB | Mode III | 246 μs | 10 μs to 50 μs |
| (Terrestrial Digital | | | |
| Audio Broadcasting) | | | |
| DVB-T | 8 MHz, 8k-IFFT, | 224 μs | 10 μs to 50 μs |
| (Digital Video | guard interval ¼ | | |
| Broadcasting - | | | |
| terrestrial) | | | |
| DVB-T2 | 8 MHz, 8k-IFFT, | 224 μs | 10 μs to 50 μs |
| (Digital Video | guard interval ¼ | | |
| Broadcasting - T2) | | | |
| DRM | Mode E (also known | 250 μs | 10 μs to 50 μs |
| (Digital Radio | as “DRM+”) | | |
| Mondial) | | | |

Preferably, the value range is in particular 10% of the guard interval or cyclic prefix of the aforementioned systems.

Further, preferably the value range is 0.2 to 0.9 microseconds in particular, whereby the guard interval or the cyclic prefix according to LTE (Long Term Evolution) in a normal cyclic prefix is 4.7 microseconds in particular.

Further, preferably the value range is 0.8 to 3 microseconds in particular, whereby the guard interval or the cyclic prefix according to LTE (Long Term Evolution) in an extended cyclic prefix is 16.7 microseconds in particular.

Further, preferably the value range is 10 to 50 microseconds in particular, whereby the guard interval or the cyclic prefix according to T-DAB (Terrestrial Digital Audio Broadcasting) in a mode III is 246 microseconds in particular.

Further, preferably the value range is 10 to 50 microseconds in particular, whereby the guard interval or the cyclic prefix according to DVB-T (Digital Video Broadcasting-terrestrial) in the variants of 8 MHz, 8k-IFFT, and guard interval 1/4 is 224 microseconds in particular.

Further, preferably the value range is 10 to 50 microseconds in particular, whereby the guard interval or the cyclic prefix according to DVB-T2 (Digital Video Broadcasting-T2) in the variants of 8 MHz, 8k-IFFT, and guard interval 1/4 is 224 microseconds in particular.

Further, preferably the value range is 10 to 50 microseconds in particular, whereby the guard interval or the cyclic prefix according to DRM (Digital Radio Mondiale) in mode E, also known as DRM+, is 250 microseconds in particular.

Further embodiment variants are possible in addition to the non limiting examples described above, without departing from the scope of the invention, comprising all the equivalent embodiments for the skilled in the art.

The elements and characteristics described in the various forms of preferred embodiments can be mutually combined without departing from the scope of the invention.

Further implementation details will not be described, as the man skilled in the art is able to carry out the invention starting from the teaching of the above description.

1. A transmission system for the transmission of an information signal (IS) in a Single Frequency Network (SFN), comprising a plurality of transmitters for the transmission of the same information signal (IS) to at least one receiver, wherein at least one transmitter of the transmission system is adapted to transmit said information signal (IS) with a time offset, wherein said time offset varies over time, thereby said information signal (IS) transmitted by said at least one transmitter is received with a second time offset by said at least one receiver, in order to enhance the reception quality and minimize a signal cancelation.

2. The transmission system according to claim 1, wherein the time offset varies in accordance with a periodic function or a random pattern.

3. The transmission system according to claim 1, wherein the transmitter is provided with a control unit (SSEE) to generate a control signal (SS) and a displacement unit to displace said information signal (IS) in time dependent on said control signal (SS), wherein said displacement unit is adapted to displace said information signal (IS) according to said over-time varying time offset dependent on said control signal (SS).

4. The transmission system according to claim 1, wherein the transmission system comprises at least two transmitters to transmit said information signal (IS) with over time varying time offsets, wherein at least two of the over-time varying time offsets are different.

5. The transmission system according to claim 1, wherein the transmission system is adapted to work according to an Orthogonal Frequency-Division Multiplexing method OFDM.

6. A transmitter adapted to transmit an information signal (IS) in a Single Frequency Network provided with an input to receive an information signal (IS) and an output, wherein the transmitter is adapted to transmit said information signal (IS) with a time offset, wherein said time offset varies over time.

7. The transmitter according to claim 6, wherein the time offset varies over time in accordance with a periodic function or a random pattern.

8. The transmitter according to claim 6, wherein the transmitter is provided with a controllable displacement unit placed between said input and said output, adapted to displace said information signal (IS), and provided with a control unit (S SEE) to generate a control signal (SS), wherein said displacement unit is provided with a control input to receive said control signal (SS) and said displacement unit is adapted to displace said information signal (IS) in accordance with said over time varying time offset.

9. A displacement unit for usage in a transmitter, wherein the displacement unit is provided with a control signal generating unit (SSEE) and a controllable delaying unit, wherein said control signal generating unit (S SEE) is adapted to generate a control signal dependent on a symbol clock of an information signal (IS) and said controllable delaying unit is adapted to delay said information signal (IS) synchronously to said symbol clock dependent on said over time varying time offset.

10. The displacement unit according to claim 8, wherein the displacement unit is realized at least partially based on software.

11. A method to transmit an information signal (IS) in a Single Frequency Network (SFN) comprising a plurality of transmitters to transmit the same information signal (IS) to at least one receiver, wherein at least one transmitter of a transmission system transmits said information signal (IS) with an over-time varying time offset.

12. A method according to claim 11 wherein the time offset varies over time in accordance to a periodic function or a random pattern.

13. The displacement unit according to claim 9, wherein the displacement unit is realized at least partially based on software.
